(19) United States
(12) Patent Application Publication
(10) Pub. No.: US 2008/0123707 A1
(43) Pub. Date: May 29, 2008

(54) RF-EXCITED GAS LASER WITH DC BIAS AND METHODS OF MANUFACTURING AND USING

(75) Inventor: Michael W. Murray, Mukilteo, WA (US)

Correspondence Address: DARBY & DARBY P.C., P.O. BOX 770, Church Street Station, New York, NY, 10008-0770, US

(73) Assignee: Synrad, Inc., Mukilteo, WA (US)

(21) Appl. No.: 11/564,739

(22) Filed: Nov. 29, 2006

(51) Int. Cl. H01S 3/00

(52) U.S. Cl. 372/38.05

(57) ABSTRACT

A RF-excited gas laser can include a metal housing containing a laser gas medium; and a first electrode and a second electrode disposed in the metal housing. The first and second electrodes are configured and arranged for coupling to a RF source for exciting the laser gas medium between the electrodes. The metal housing and first and second electrodes are configured and arranged for application of a DC bias between i) the metal housing and ii) at least one of the first and second electrodes. Optionally, a DC bias can be applied between i) the metal housing and ii) both the first and second electrodes.

### FIELD

The present invention is directed to RF-excited gas lasers and methods of manufacturing and using the lasers. The present invention is also directed to RF-excited gas lasers with electrodes disposed in a metal housing and methods of manufacturing and using the gas lasers.

### BACKGROUND

A radio frequency (RF)-excited gas laser produces laser energy when a gas medium within the laser is excited by the application of RF energy between one or more pairs of electrodes. One example of a gas laser is a carbon dioxide laser. Metal sealed gas lasers have found many applications because of their compact size, reliability, and relative ease of manufacture.

RF-excited gas lasers that include RF electrodes within a metal gas envelope produce regions of high electric field strength where gas discharge can take place. Typically, the desired region is situated between the electrodes where laser gain is produced. There can be, however, other regions within the gas laser with high electric field strength where gas discharges may occur. These ancillary gas discharges are generally undesirable because they can rob RF power from the desired region. In addition, the ancillary discharges may be intermittent in nature which may lead to random fluctuations in the output power of the laser.

Undesirable regions of high RF electric field strength can include those portions of the laser where an electrode is near the metal gas envelope (i.e., metal housing.) Some conventional gas lasers have sought to suppress these ancillary discharges by making the separation between the electrodes and the housing large or by placing a dielectric material in the region to displace the gas. This can increase the size of the metal gas envelope and increase the material cost of the laser, both of which may be undesirable consequences.

### BRIEF SUMMARY

One embodiment is a RF-excited gas laser including a metal housing containing a laser gas medium; and a first electrode and a second electrode disposed in the metal housing. The first and second electrodes are configured and arranged for coupling to a RF source for exciting the laser gas medium between the electrodes. The metal housing and first and second electrodes are configured and arranged for application of a DC bias between i) the metal housing and ii) at least one of the first and second electrodes.

Another embodiment is a laser system including a RF source; a metal housing containing a laser gas medium; a first electrode and a second electrode disposed in the metal housing and coupled to the RF source for exciting the laser gas medium between the electrodes; and a DC bias circuit coupled to the first and second electrodes and configured and arranged for application of a DC bias between i) the metal housing and ii) at least one of the first and second electrodes.

Yet another embodiment is a method of operating a RF-excited gas laser by providing RF energy to at least one pair of electrodes disposed within a metal housing containing a laser gas medium to excite the laser gas medium between the at least one pair of electrodes. A DC bias is applied between the metal housing and at least one of the electrodes.

Optionally, for any of these embodiments, a DC bias can be applied between i) the metal housing and ii) both the first and second electrodes. Any suitable circuitry or method can be used for applying the DC bias including, but not limited to, applying the DC bias using a DC supply or by rectifying an RF signal.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a schematic diagram of a RF-excited gas laser, according to the invention;

FIG. 2 is a schematic cross-sectional view of one embodiment of a laser gain region of the gas laser of FIG. 1, according to the invention;

FIG. 3 is a schematic block diagram of one embodiment of a gas laser with an applied DC bias between the electrodes and metal housing, according to the invention;

FIG. 4 is a schematic block diagram of a second embodiment of a gas laser with an applied DC bias between the electrodes and metal housing, according to the invention;

FIG. 5 is a schematic block diagram of a third embodiment of a gas laser with an applied DC bias between the electrodes and metal housing, according to the invention;

FIG. 6 is a schematic block diagram of a fourth embodiment of a gas laser with an applied DC bias between the electrodes and metal housing, according to the invention; and

FIG. 7 is a schematic block diagram of a fifth embodiment of a gas laser with an applied DC bias between the electrodes and metal housing, according to the invention.

### DETAILED DESCRIPTION

The present invention is directed to RF-excited gas lasers and methods of manufacturing and using the lasers. The present invention is also directed to RF-excited gas lasers with electrodes disposed in a metal housing and methods of manufacturing and using the gas lasers.

The RF-excited gas laser typically includes one or more pairs of electrodes disposed within a metal gas envelope containing a laser gas medium, such as carbon dioxide, helium-xenon, nitrogen, hydrogen fluoride, deuterium fluoride, copper vapor, gold vapor, and the like. Examples of RF-excited gas lasers that can be modified to include a DC bias, according to the present invention, include those described in U.S. Pat. Nos. 4,805,182; 5,602,865; and 5,953,360, incorporated herein by reference. Other suitable RF-excited gas lasers include, but are not limited to, those commercially available from Synrad, Inc. (Mukilteo, Wash.). It will be recognized that the application of a DC bias can be used with many other RF-excited gas laser configurations.

Generally, desirable gas discharge occurs within the laser gain region between the RF electrodes when a RF field is applied. Unwanted ancillary gas discharge can occur in other regions with a strong RF electric field, such as in regions between the electrodes and the metal gas envelope. This discharge does not substantially contribute to the laser energy and may divert energy away from the laser gain region. A DC bias electric field can be applied between the RF electrodes and the metal gas envelope (e.g., housing) of the RF-excited gas laser to reduce, or even substantially eliminate, the ancillary gas discharge. While not wishing to be bound by any particular theory, it is believed that the DC bias electric field sweeps electrons out of those regions where the electrodes and the metal gas envelope are close to each other. This effect can result in reduction or elimination of ancillary gas discharge.

The application of a DC bias electric field between the RF electrodes and the metal gas envelope may also shape or enhance the RF electric field between the electrodes and the corresponding desired gas discharges. It is thought that the DC bias electric field may partially, or even fully, suppress the RF electric field between the RF electrodes and the metal gas envelope except in the desired region between the RF electrodes. This suppression may even occur in those regions where there is little or no ancillary gas discharge.

Any method for applying a DC bias electric field can be used. For example, the DC bias can be generated using a DC supply. As another example, the DC bias can be generated by rectifying a RF signal. Optionally, the RF signal can be from the same RF source that is used to generate the RF electric field.

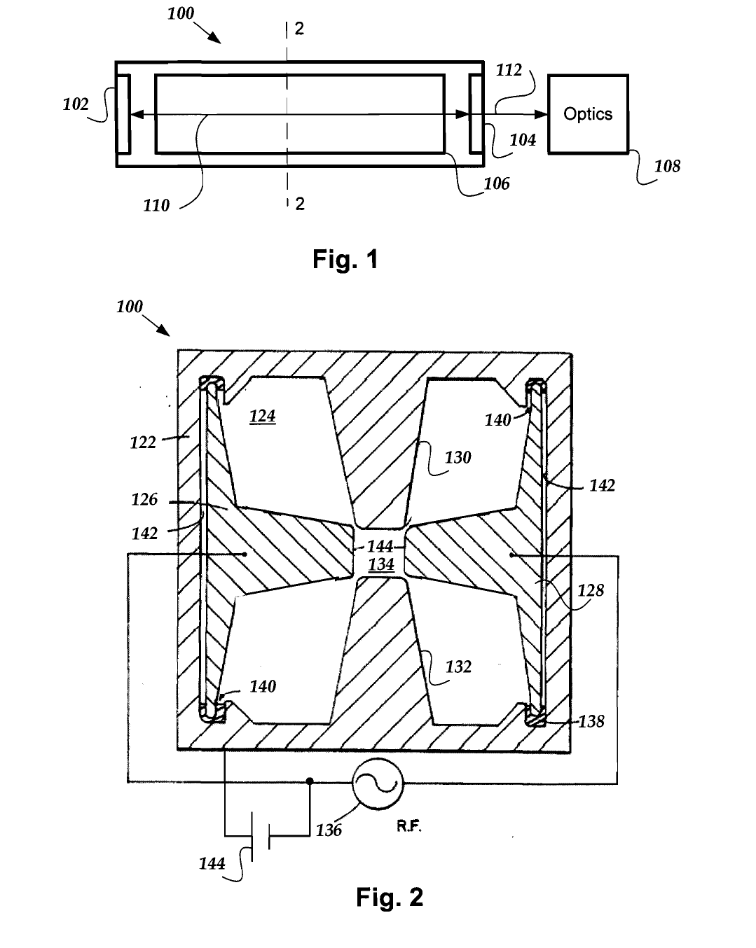

FIG. 1 illustrates schematically one embodiment of a RF-excited gas laser 100. The gas laser typically includes a first mirror 102, an output coupler 104, a gain region 106, and, optionally, additional optics 108. A laser gas medium, such as carbon dioxide, is excited by electrodes within the gain region 106, as discussed in more detail below, to generate light 110. The mirror 102 and output coupler 104 define a resonant laser cavity within which the light 110 travels. Although the output coupler reflects a portion of the light back towards the mirror 102, it also transmits a portion 112 of the light to the additional optics 108 which may deliver, focus, collimate, expand, or otherwise operate on the light 112. The configuration and materials of the first mirror 102 and output coupler 104, as well as the length of the gain region 106, can be selected to provide desired laser output power and efficiency.

FIG. 2 schematically illustrates a cross-sectional view of one embodiment of the gain region and its surroundings in a RF-excited gas laser 100. The laser 100 includes a metal housing 122 (also referred to as a metal gas envelope) which defines a chamber 124. A laser gas medium, such as carbon dioxide, is dispersed throughout the chamber 124. The metal housing 122 optionally includes arms 130, 132 that extend into the chamber 124. The chamber 124 may extend from the first mirror 102 (FIG. 1) to the output coupler 104 (FIG. 1) and includes the laser resonant cavity.

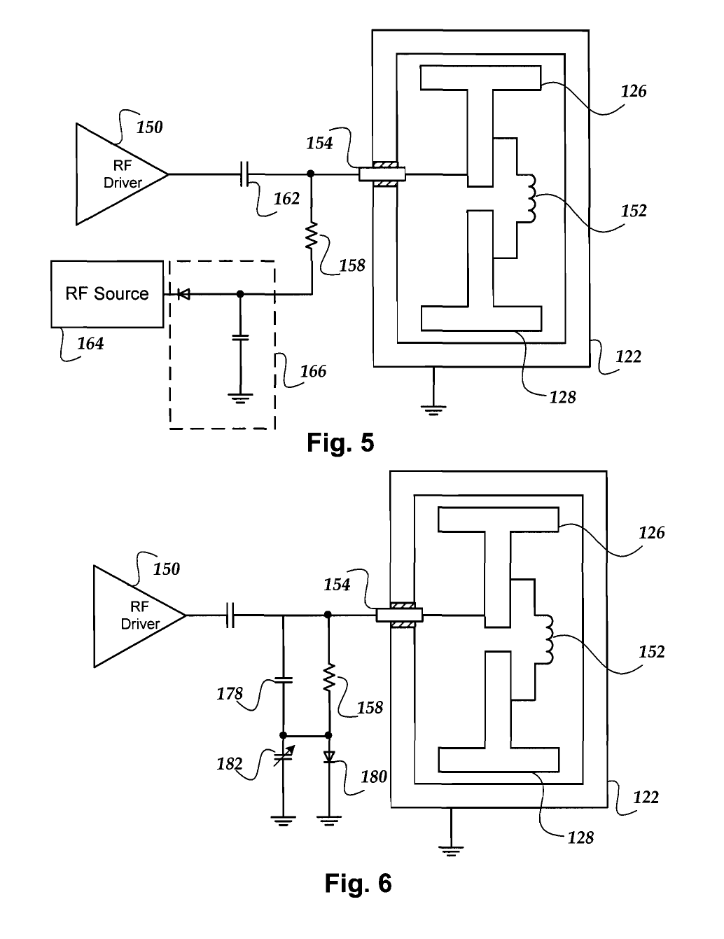

The laser 100 also includes at least one pair of electrodes 126, 128. The electrodes 126, 128 typically extend along the length of the laser gain region 106 25 (FIG. 1). Portions of the electrodes 126, 128 extend toward the center of the chamber 124 as illustrated in FIG. 2, although other configurations can be used. In many instances, the pair of electrodes 126, 128, in combination with another pair of electrodes (see FIG. 5) or with the arms 130, 132 of the metal housing 122, define a RF region 134 therebetween in which it is desirable to direct the RF power as this is the region in which the laser light is generated. Examples of other suitable arrangements of the electrodes and housing can be found in U.S. Pat. Nos. 4,805,182; 5,602,865; and 5,953,360, incorporated herein by reference. The application of a DC bias, as described herein, can be utilized in these arrangements and many others.

The metal housing 122, and electrodes 126, 128 can be formed of any conductive material including metals, alloys, and the like. In one embodiment, the metal housing and electrodes are formed of aluminum. The electrodes 126, 128 can be bare metal, have a metallic coating, or be anodized to form a thin coating over at least a portion of the surface of the electrode. Anodization may raise the DC breakdown voltage threshold and allow higher values of DC bias voltage to be used.

A RF source 136 is typically coupled to the electrodes 126, 128. The metal housing 122 is typically grounded. The RF source provides RF excitation energy. In at least one embodiment, the RF energy is in the 20 to 200 MHz range and preferably at about 40 or 81 MHz. The RF signal can be continuous wave (CW) or pulsed.

The electrodes 126, 128 are typically separated from the metal housing 122 using non-conductive spacers 138 leaving gaps 142. The gaps can permit exchange or flow of the laser gas medium and may provide some convection cooling of the electrode. Preferably, the gaps 142 are sufficiently narrow that substantial gas discharge does not occur. However, there are generally regions 140 where the distance between the electrodes 126, 128 and the metal housing 122 are sufficiently spaced so that gas discharge may occur if a sufficient RF electric field is present.

To reduce gas discharge in regions other than RF region 134, a DC bias 144 is applied between the metal housing 122 and the electrodes 126, 128. The sign of the bias (positive or negative) will typically depend on the laser configuration and can be easily determined.

In at least some embodiments, the magnitude of the applied DC bias is at least 50 Volts, at least 100 Volts, at least 150 Volts, or more. It was found that, in at least some instances, the reduction of ancillary gas discharge (i.e., gas discharge outside the RF region) decreased with increasing DC bias voltage until a threshold level was met when, it is believed, substantially all of the ancillary gas discharge is halted. The application of a DC bias can reduce the ancillary gas discharge by at least 25%, at least 50%, at least 75%, at least 90%, at least 99%, or more. In some embodiments, the magnitude of the threshold level is at least 50 Volts, at least 75 Volts, at least 100 Volts, at least 150 Volts, or more. Preferably, the applied DC bias exceeds the threshold level; although lower levels of DC bias will provide some reduction in ancillary gas discharge.

One method for observing or measuring the ancillary discharges includes producing a special laser tube with one or more windows installed to allow observation of the regions where ancillary discharges occur. When the laser is powered up lines of glowing gas can be observed along the regions 140 between the RF electrodes and the housing when ancillary discharges are present. As the DC bias voltage is raised the ancillary discharges will become less luminous and dark segments of unlit discharge start to appear. A further increase in DC bias voltage shrinks the ancillary discharges down to a few locations, which may flicker on and off and sometimes move about along the regions 140. When the DC bias voltage reaches a threshold level the remaining ancillary discharge extinguish completely and all regions 140 are dark.

There is generally an upper limit to the amount of DC bias that can be applied before DC breakdown occurs and current flows between the electrodes and the metal housing. The DC breakdown voltage will depend on, for example, the geometry of the metal housing and electrodes. In some embodiments, the DC breakdown voltage is in the range of 225 to 450 volts.

Application of a DC bias may also facilitate redistribution of the RF power into the desired center RF region 134. Such a redistribution is particularly advantageous because the most desirable optical mode passes through a circular cross-sectional area centered in this RF region 134. The presence of a DC field between the electrodes 126, 128 and arms 130, 132 will be strongest where the electrodes and arms are closest and may even serve to redistribute the RF power deposited within the RF region 134 toward the center of the RF region 134. In an alternative arrangement, where arms 130, 132 are not present there is generally no significant DC electric field between the RF electrodes 126, 128.

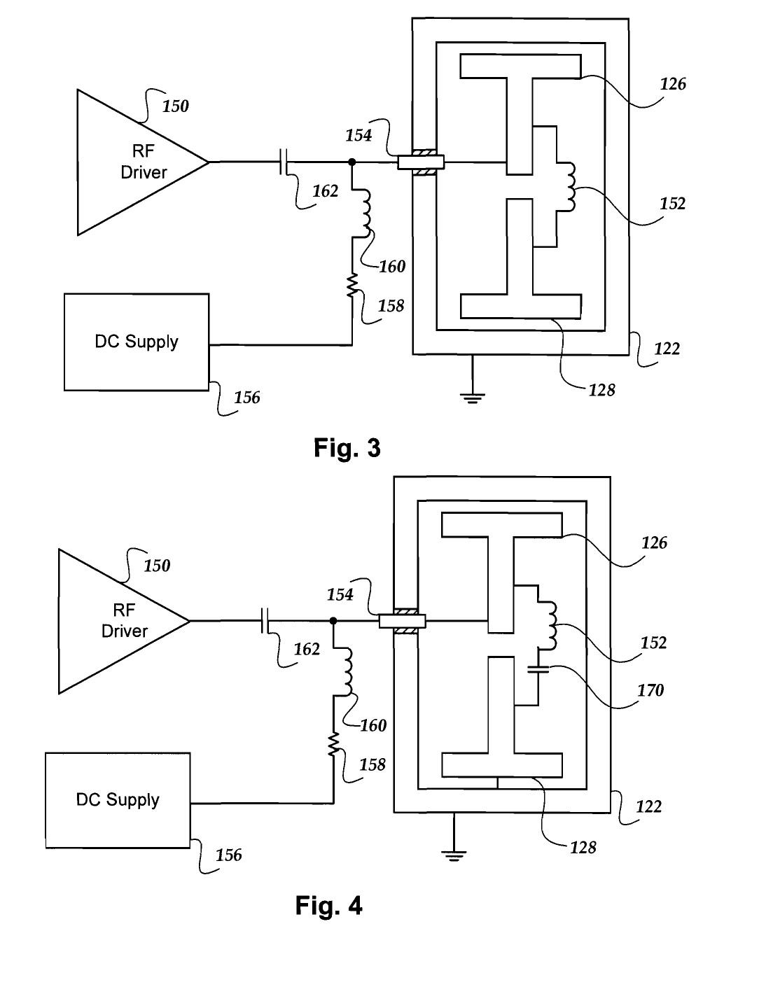

FIG. 3 illustrates schematically one embodiment of a laser system for application of a DC bias. In this embodiment, a RF driver 150 provides the RF excitation energy to the electrodes 126, 128 through an electrically insulated tap 154 in the metal housing 122. These electrodes are coupled together by an inductor 152 to provide anti-phase excitation of the electrodes. The metal housing 122 is grounded.

A DC bias is provided by a DC supply 156. Any DC supply that can produce the desired DC bias voltage can be used. Preferably, the DC supply is a low power supply (for example, providing up to a few hundred milliwatts). The voltage supplied by the DC supply may be fixed or variable.

Preferably, the DC bias is provided through a resistor with a relatively high resistance value (e.g., at least 100K or 1M) to limit the current and to isolate the DC supply should there be an arc between the electrodes. The high resistance can also prevent or reduce the DC supply from loading the RF driver by making the RF impedance of the DC bias circuit at the tap much larger than the RF impedance of the laser tube itself.

A series inductor 160 may optionally be added to resist the flow of RF current into the DC supply 156. In one embodiment, the inductor has a value in the range of 300 to 600 nH. The inductor 160 may also raise the RF impedance presented by the DC supply 156.

A DC blocking capacitor 162 may also be used to resist application of the DC bias to the RF driver 150. In one embodiment, the capacitor has a value in the range of 500 to 1000 pF.

Optionally a small capacitor (not shown), on the order of 10 to 500 pF, can be placed in shunt with the DC supply 156 to provide a low RF impedance path to ground for any residual RF current that manages to flow through resistor 158. This further assures that RF current will not get into the DC supply and cause interference with the normal operation of the supply.

Another optional capacitor (not shown) can be placed in shunt with the node between the resistor 158 and the inductor 160. This capacitor can also provide a low impedance path to ground for residual RF current. In one embodiment, the capacitor value is on the order of 10 to 1000 pF. This second capacitor may also perform an additional function. As mentioned above, the potential exists for an arc to occur between the electrode 126 or 128 and the laser housing 122. Such an arc may be caused by a small metal particle that is inadvertently trapped inside the laser tube during manufacturing. The trapped metal particle will have no effect on laser operation unless the particle happens to become lodged in one of the narrow gaps 142 between an electrode and the housing. Once trapped in the gap 142 the particle may produce a fault, causing a malfunction of the RF driver. However, if the second capacitor is chosen to have a value on the order of, for example, 1000 pF to 1 μF (or more) there may be enough energy stored in the capacitor to vaporize the metal particle and clear the fault. It is also thought that the capacitance of the laser tube and RF driver alone, will provide some amount of stored energy for fault clearing action, when DC bias is applied. However, adding a capacitor and an inductor, in series combination, can increase the energy storage capacitance. The RF impedance of the series inductor-capacitor combination is preferably large and the DC resistance of the inductor is preferably small.

FIG. 4 illustrates schematically another embodiment of a gas laser in which one of the electrodes 128 is electrically coupled to the housing 122. In this arrangement, a DC blocking capacitor 170 is disposed between the two electrodes 126, 128. Moreover, in this particular configuration, unlike in the arrangement of FIG. 3, a DC field may be formed between the two electrodes 126, 128. Otherwise, the embodiment of FIG. 4 operates in a similar manner to the embodiment of FIG. 3.

FIG. 5 illustrates schematically another embodiment of a gas laser. In this embodiment, the DC bias is generated by rectification of a RF signal from a RF source 164. (It will be recognized that a DC bias can be generated by rectification of any AC signal, not just a RF signal so other AC signal sources can be used.) In one embodiment, the RF driver 150 also acts as the RF source 164.

The rectification of the RF signal is performed using a rectifier circuit 166 such as that illustrated in FIG. 5. Any suitable rectifier circuit can be used in place of the diode/grounded capacitor combination illustrated in FIG. 5. The rectified RF signal is provided to the electrodes through resistor 158 which preferably has a large resistance value (e.g., at least 100K or 1M) to limit current.

FIG. 6 illustrates schematically another embodiment of a gas laser using a rectified RF signal to provide a DC bias. In this particular illustrated embodiment, the rectified RF signal is from the RF driver 150. The fixed capacitor 178 and the variable capacitor 182 form a high RF impedance voltage divider circuit, which produces a DC bias voltage on the variable capacitor due to the rectifying action of the diode 180 in shunt with the variable capacitor 182. The DC bias voltage is adjusted by adjusting the variable capacitor 182. The DC bias voltage is applied to the laser tap via the high impedance resistor 158.

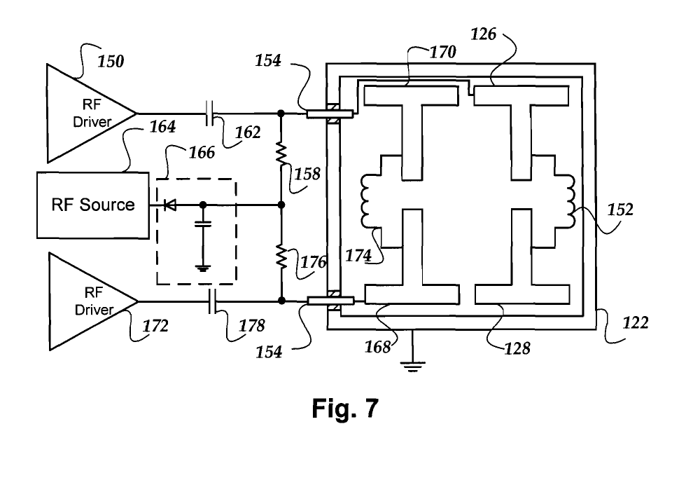

FIG. 7 illustrates schematically another embodiment of a gas laser. This embodiment includes two side-by-side electrode pairs (electrodes 126, 128 and electrodes 168, 170). Each electrode pair is coupled to a respective RF driver 150, 172 through a tap 154 in the metal housing 122. The RF drivers may be the same or different. An inductor 152, 174 couples each pair of electrodes. The desired gain region is between each pair of electrodes. Turning optics (not shown) can be used to combine the two gain regions resulting in a more compact laser tube structure.

The DC bias is provided in this embodiment by a RF source 164 and rectifier circuit 166. It will be recognized that other embodiments could include the DC supply of FIG. 3 to provide the DC bias or that an individual DC bias generator (using a DC supply or rectified RF signal) could be provided separately for each pair of electrodes. In the embodiment of FIG. 5, a single RF source 164 and rectifier circuit 166 provides the DC bias for each pair of electrodes through resistors 158, 176 which preferably have a large resistance value as described above. DC blocking capacitors 162, 178 are provided to resist application of the DC bias to the respective RF drivers 150, 172. Optionally, one of both of the RF drivers 150, 172 can act as the RF source.

As described above, the application of a DC bias using the DC supply 156 of FIG. 3 or the rectified RF source(s) of FIGS. 4 and 5 can reduce ancillary gas discharge in unwanted regions of the gas laser.

The above specification, examples and data provide a description of the manufacture and use of the composition of the invention. Since many embodiments of the invention can be made without departing from the spirit and scope of the invention, the invention also resides in the claims hereinafter appended.

What is claimed as new and desired to be protected by Letters Patent of the United States is:

1. A RF-excited gas laser, comprising:
a metal housing containing a laser gas medium; and
a first electrode and a second electrode disposed in the metal housing, wherein the first and second electrodes are configured and arranged for coupling to a RF source for exciting the laser gas medium between the electrodes;
wherein the metal housing and first and second electrodes are configured and arranged for application of a DC bias between i) the metal housing and ii) at least one of the first and second electrodes.

2. The gas laser of claim 1, further comprising a DC bias circuit coupled to the first and second electrodes to provide the DC bias between the housing and the first and second electrodes.

3. The gas laser of claim 2, wherein the DC bias circuit is configured and arranged for coupling to a DC supply to provide the DC bias.

4. The gas laser of claim 3, further comprising the DC supply coupled to the DC bias circuit.

5. The gas laser of claim 2, wherein the DC bias circuit is configured and arranged to rectify a RF signal to provide the DC bias.

6. The gas laser of claim 5, further comprising an RF source coupled to the DC bias circuit.

7. The gas laser of claim 6, further comprising the RF source coupled to the first and second electrodes and to the DC bias circuit.

8. The gas laser of claim 1, further comprising the RF source coupled to the first and second electrodes.

9. The gas laser of claim 1, further comprising a third electrode and a fourth electrode disposed in the metal housing, wherein the third and fourth electrodes are configured and arranged for coupling to a RF source for exciting the laser gas medium between the electrodes.

10. The gas laser of claim 1, wherein the metal housing and third and fourth electrodes are configured and arranged for application of a DC bias between i) the metal housing and ii) at least one of the third and fourth electrodes.

11. A laser system, comprising:
a RF source;
a metal housing containing a laser gas medium;
a first electrode and a second electrode disposed in the metal housing and coupled to the RF source for exciting the laser gas medium between the electrodes; and
a DC bias circuit coupled to the first and second electrodes and configured and arranged for application of a DC bias between i) the metal housing and ii) at least one of the first and second electrodes.

12. The laser system of claim 11, wherein the DC bias circuit is configured and arranged to rectify a RF signal to produce the DC bias.

13. The laser system of claim 11, wherein the DC bias circuit comprises a power source to produce the DC bias.

14. The laser system of claim 11, wherein the DC bias circuit is configured and arranged to provide a DC bias of at least 50 Volts in magnitude.

15. The laser system of claim 11, wherein the DC bias circuit is configured and arranged to provide a DC bias of at least 100 Volts in magnitude.

16. A method of operating a RF-excited gas laser, the method comprising:
providing RF energy to at least one pair of electrodes disposed within a metal housing containing a laser gas medium to excite the laser gas medium between the at least one pair of electrodes; and
applying a DC bias between the metal housing and at least one of the electrodes.

17. The method of claim 16, wherein applying a DC bias comprises applying a DC bias of at least 50 volts in magnitude.

18. The method of claim 16, wherein applying a DC bias comprises applying a DC bias of at least 100 volts in magnitude.

19. The method of claim 16, wherein applying a DC bias comprises applying a DC bias using a DC supply.

20. The method of claim 16, wherein applying a DC bias comprises rectifying a RF signal to generate a DC bias.
